(19) United States
(12) Patent Application Publication
(10) Pub. No.: US 2024/0143470 A1
(43) Pub. Date: May 2, 2024

(54) SLICED FLOW TELEMETRY FOR FULL NETWORK VISIBILITY WITH LIMITED HARDWARE RESOURCES

(71) Applicant: Cisco Technology, Inc., San Jose, CA (US)

(72) Inventors: Mankamana Prasad Mishra, San Jose, CA (US); Rajiv Asati, Morrisville, NC (US); Nitin Kumar, San Jose, CA (US)

(21) Appl. No.: 17/973,850

(22) Filed: Oct. 26, 2022

(51) Int. Cl. G06F 11/30; G06F 9/50; G06F 11/07

(52) U.S. Cl. CPC G06F 11/3051; G06F 9/5044; G06F 11/0766; G06F 2209/508

(57) ABSTRACT

In one embodiment, a method herein comprises: determining a set of flows to be monitored within a computer network; determining, by the device, a set of nodes within the computer network through which the set of flows traverse; determining monitoring capabilities for the set of nodes; generating an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and instructing the set of nodes to monitor the set of flows according to the assignment for each particular node of the set of nodes.

### TECHNICAL FIELD

The present disclosure relates generally to computer systems, and, more particularly, to sliced flow telemetry for full network visibility with limited hardware resources.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

In particular, operations teams would like to get a complete view of their networks using telemetry data to visualize what is happening across their networks. With respect to multicast telemetry, for example, as the number of flows are increasing in the network, there is also a corresponding increase in telemetry data, creating problems in terms of bandwidth, processing power, and general network resources.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example graph showing a challenge with a trend in flow monitoring technology;

FIG. 4 illustrates an example multicast network in which time sharing slice based network telemetry collection herein can be configured;

FIG. 5 illustrates an example diagram of a procedure for creating a number of buckets and distributing flows into those buckets;

FIG. 6 illustrates an example diagram of a portion of a network of nodes;

FIG. 7 illustrates an example topology of nodes with flows;

FIG. 8 illustrates an example of the topology in FIG. 7 where each node only monitors one flow at a time, but where all flows are monitored through the topology; and

FIG. 9 illustrates an example simplified procedure for sliced flow telemetry for full network visibility with limited hardware resources in accordance with one or more embodiments described herein.

### DESCRIPTION OF EXAMPLE EMBODIMENTS

### Overview

According to one or more embodiments of the disclosure, an illustrative method herein may comprise: determining, by a device, a set of flows to be monitored within a computer network; determining, by the device, a set of nodes within the computer network through which the set of flows traverse; determining, by the device, monitoring capabilities for the set of nodes; generating, by the device, an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and instructing, by the device, the set of nodes to monitor the set of flows according to the assignment for each particular node of the set of nodes.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

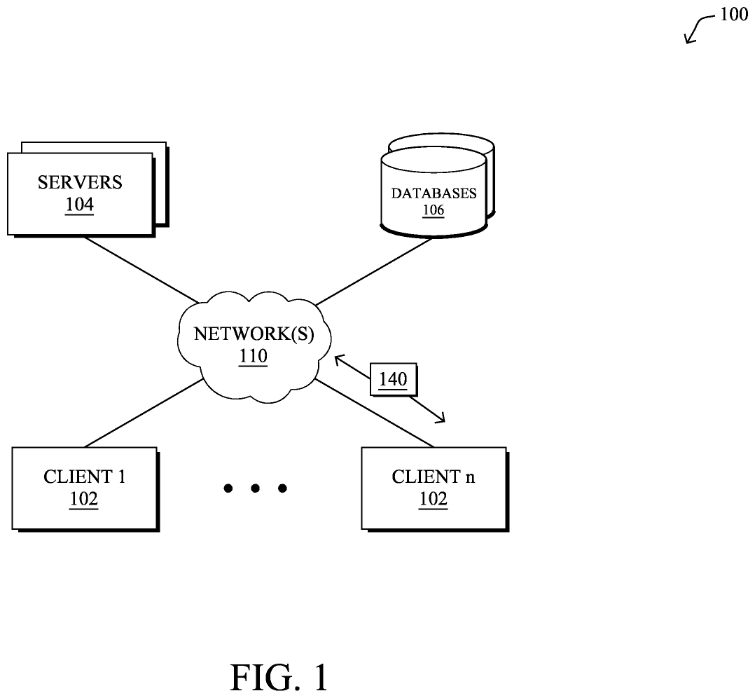

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

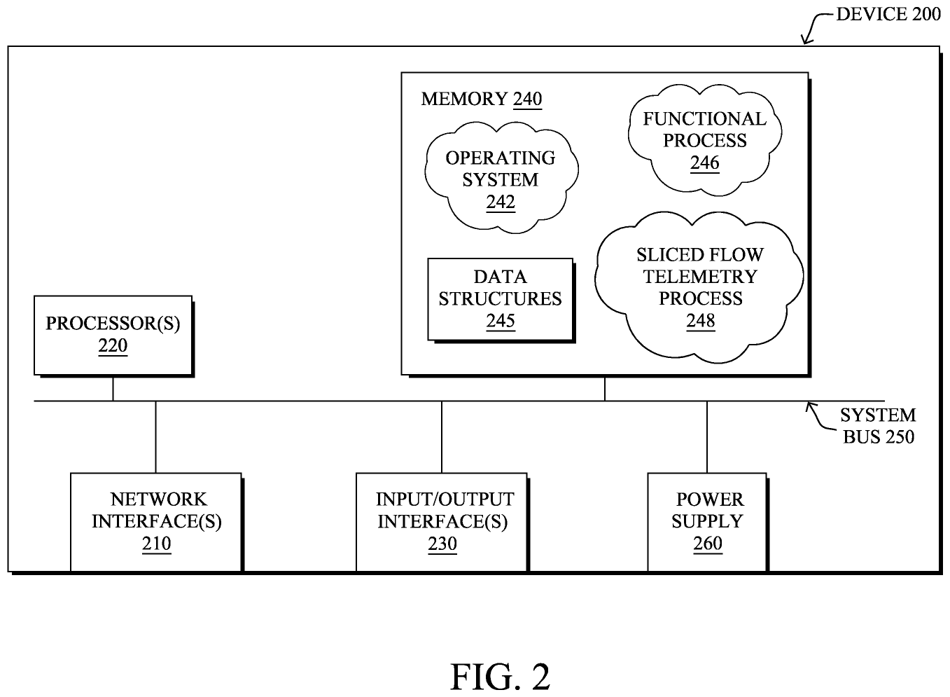

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “sliced flow telemetry” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

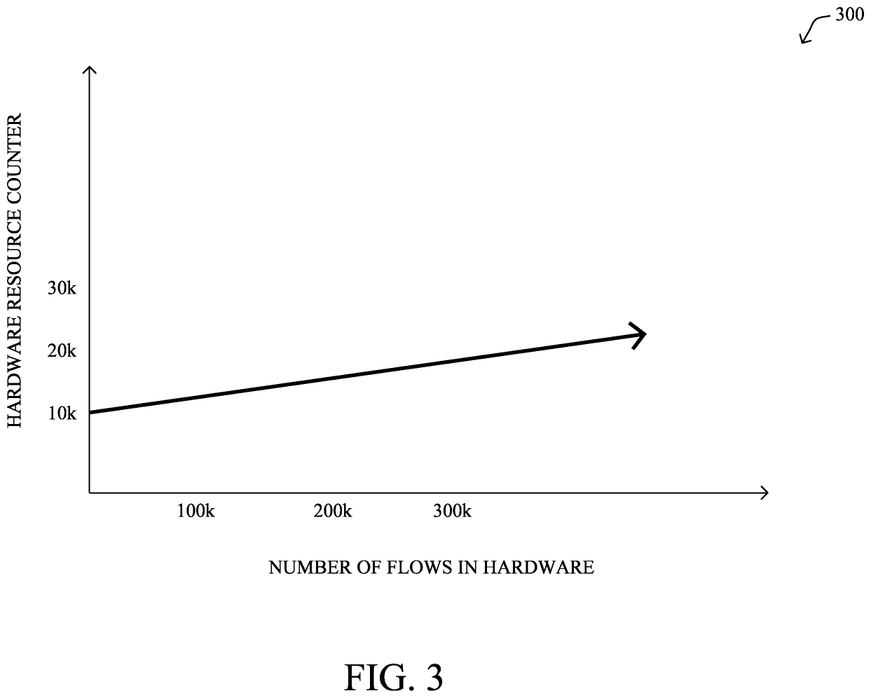

—Sliced Flow Telemetry for Full Network Visibility—As noted above, operations teams would like a complete view of their networks using telemetry data to visualize what is happening across their networks. However, as also noted above, as the number of multicast flows (e.g., video flows) are increasing in the network, there is also a corresponding increase in telemetry data (e.g., 1000 flows per second), creating problems in terms of bandwidth, processing power, and general network resources. While supporting counters per flow helps to provide enough telemetry data to visualize complete network view by operation team, FIG. 3 illustrates a graph 300 showing a challenge with a trend in technology. In particular, to be able to export telemetry data for given flow, counters are needed (which translates to hardware resources) in the platform per flow. But with time, typical port capacity is increasing exponentially whereas hardware resources for counters are not increasing with the same ratio. As such, the challenge presents itself as per flow counters cannot be supported for high-scale multicast deployments, and customers cannot have their desired network visibility (e.g., for monitoring user experience), accordingly.

For example, assume a network monitoring customer with approximately 300,000 multicast flows in their network. Even though newer hardware and ASICs have grown exponentially with respect to port density and bandwidth support, the amount of hardware resources which are needed to enable monitoring are still very limited. As customers like this are looking for ways to visualize their network and monitor overall health, it is crucial that monitoring services scale to be able to monitor all the flows in network at any given point of time.

The techniques herein, therefore, provide for sliced flow telemetry for full network visibility with limited hardware resources. In particular, the present disclosure defines a new concept of network “slicing” for monitoring purposes in order to have better visibility of the network with only limited hardware resources. That is, the techniques herein are able to distribute 100% of the flows across network into different logical slices, which would help to monitor flows simultaneously with a high degree of scalability. Algorithms are defined herein to formulate which flows are to be monitored by which group of devices, ensuring maximum coverage within those groups (or multiples of those groups). For a simplified example, for instance, assuming 4000 total flows, the techniques herein may divide these 4000 flows into groups, e.g., of 100 flows, and may then program these 100 flows to be monitored on certain subsets of devices (i.e., which group of flows are monitored on which particular devices).

Specifically, according to one or more embodiments described herein, the techniques herein are based generally on determining a set of flows to be monitored within a computer network, determining a set of nodes within the computer network through which the set of flows traverse, and determining monitoring capabilities for the set of nodes, and then generating an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes. The techniques herein thus instruct the set of nodes to monitor the set of flows according to the assignment for each particular node of the set of nodes, accordingly.

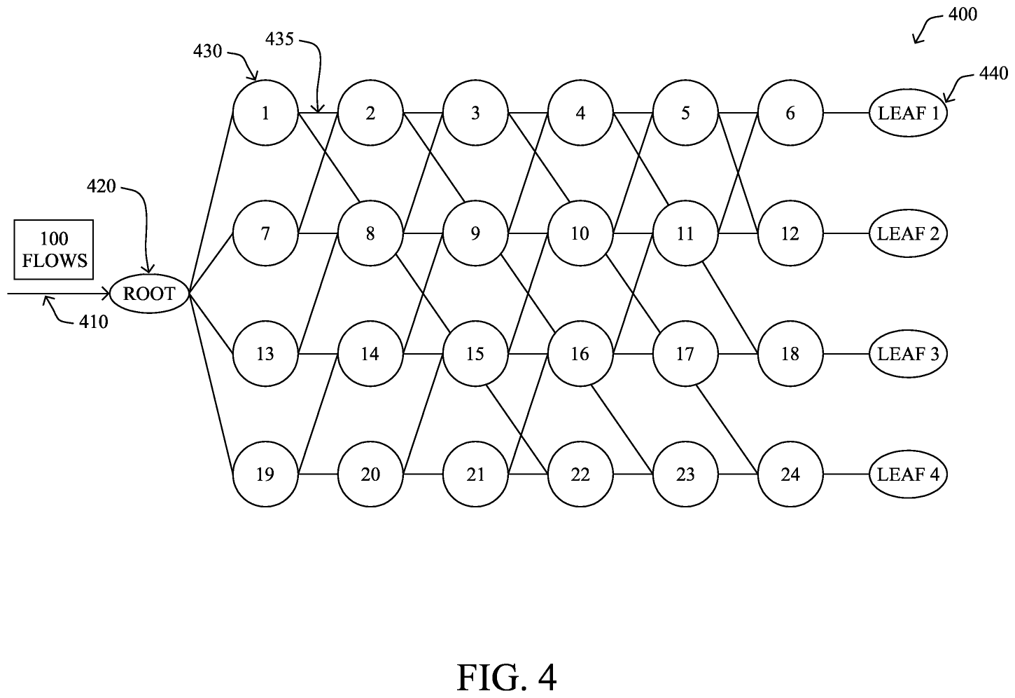

Operationally, the techniques herein begin with an understanding/awareness of the network topology, hardware resources per hop, total number of flows (e.g., and types of flows) so as to formulate appropriate per-hop policies for monitoring as described herein. For instance, FIG. 4 illustrates an example multicast network 400 in which time sharing slice based network telemetry collection herein can be configured. Assume, for example, that the total number of flows 410 available is one hundred (100) through a root 420, through a number of nodes 430 (e.g., “F” through “24”) interconnected by links 435 to a set of leaf nodes 440 (e.g., “leaf 1” through “leaf 4”). Also assume, for example, that the total number of counters (hardware resources) in each device is fifty (50), a simplification for purposes of demonstration in the present disclosure.

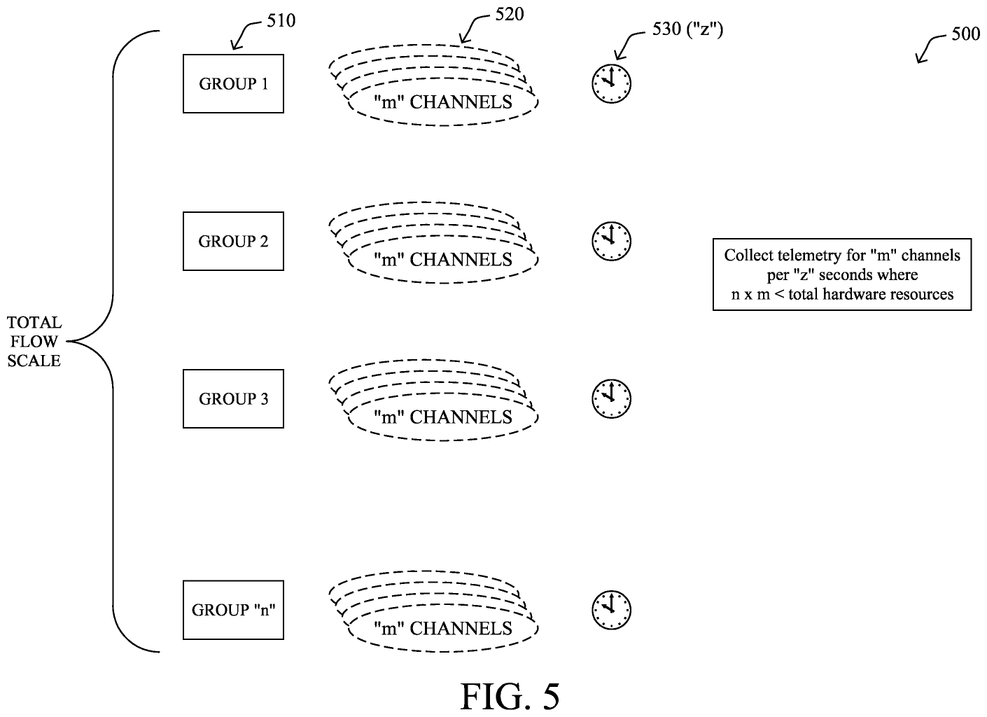

According to the techniques herein, and with reference generally to the diagram 500 of FIG. 5, an example procedure for one or more embodiments herein may be to create “n” number of buckets 510 (e.g., “group 1” through “group ‘n’”), and then distribute/group the total flows into those “n” buckets (e.g., logically, based on flow characteristics, or otherwise, such as randomly, equally, round-robin, etc.). Thereafter, with the n # of groups, m # of channels 520 in each group may then be assigned to be monitored for collecting telemetry over z # time-period 530, such that m×n is less than the hardware resource limitation of the nodes.

As an example from the above topology, consider the total number of one hundred (100) flows where fifty (50) hardware resources are available for monitoring. The techniques herein may illustratively then create ten (10) groups (buckets) and then map ten (10) flows to each of the groups. Now, statistics may be collected continuously, or else may be turned on periodically for “z” seconds for two (2) flows per group. So now every “z” seconds, the techniques herein would be using only twenty (20) hardware resources, accordingly.

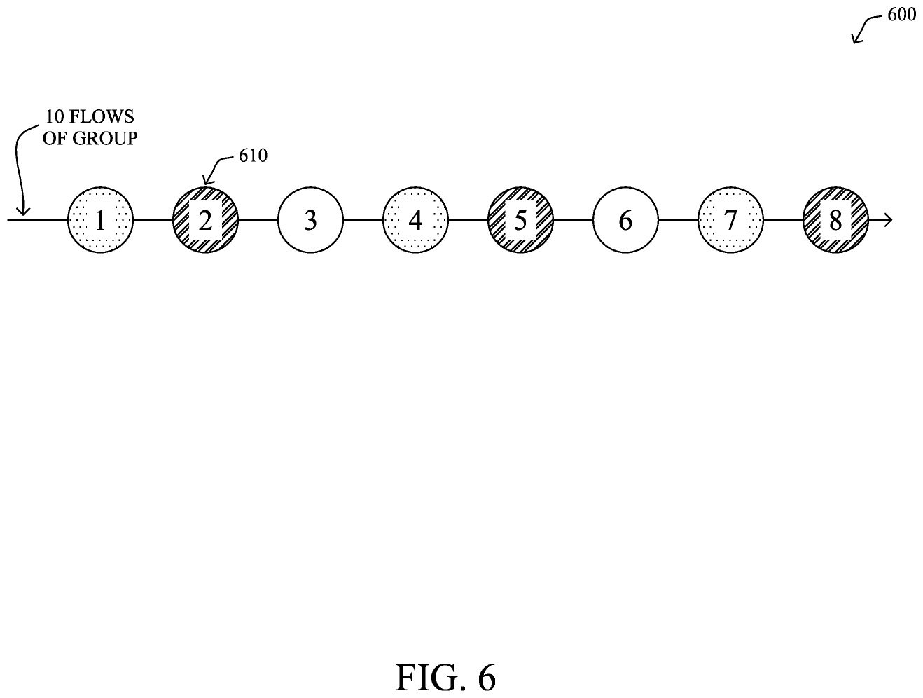

As an additional or alternative optimization of hardware resources according to the techniques herein, and with reference generally to the diagram 600 of FIG. 6, given that there could be A # of hops (nodes 610) on a path between ingress and egress (e.g., eight as shown), different devices may be configured to monitor different flows, accordingly. For example, as shown, an example distribution may be to have hops #1, #4, and #7 be assigned to one set of m×n channels being hardware monitored, whereas hops #2, #5, and #8 may have another set or m×n being hardware monitored, and so on (e.g., with hops #3 and #6 either monitoring a different set of flows, or no flows, or other configurations, such as based on capability, availability, need, and so on). This allows the techniques herein to distribute a greater number of flows to be monitored across the network, such that almost all (e.g., all) of the flows/channels get monitored through the network on certain subsets of hops.

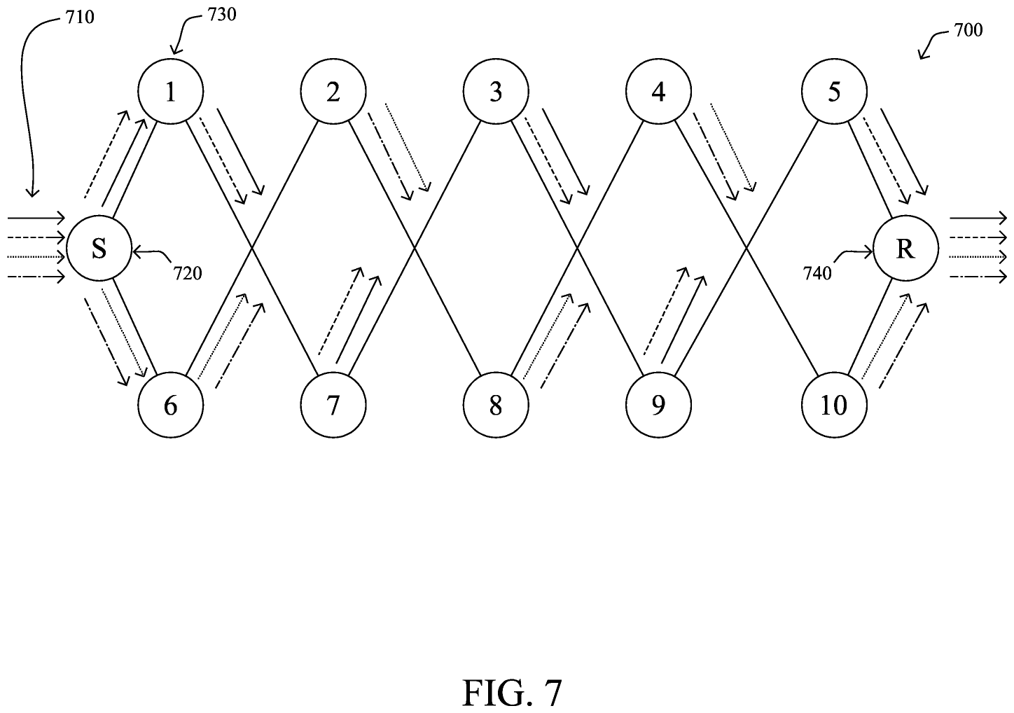

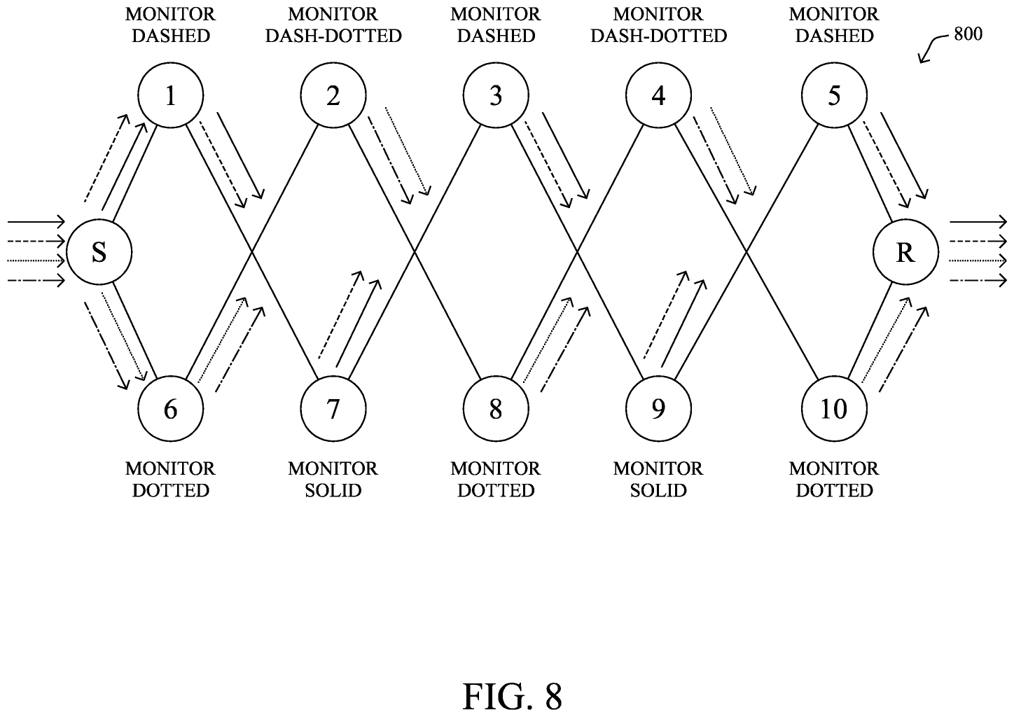

To illustrate the benefit of the techniques herein over known monitoring services, FIG. 7 illustrates an example topology 700 where flows 710, referred to and shown herein as “solid”, “dashed”, “dotted”, and “dash-dotted”, traverse from a source “S” 720, through a number of nodes 730 (e.g., routers 1-10) to a receiver “R” 740. Consider that each of the nodes/routers in network can monitor only one flow at a time. Now, any existing monitoring service is only going to be able to monitor one of the flows at a time, and then move to next, which creates more vacuum in terms of visibility for the operator. As shown in the topology 800 of FIG. 8, where the procedure defined herein creates slices for monitoring within network, better visibility is thus provided. That is, while keeping the same hardware limitations in mind, the techniques herein have distributed the monitoring across different slices in network (e.g., nodes 1, 3, and 5 monitoring the dashed flow, nodes 6, 8, and 10 monitoring the dotted flow, nodes 2 and 4 monitoring the dash-dotted flow, and nodes 7 and 9 monitoring the solid flow). As such, the techniques herein are able to achieve substantially fair data for all of the flows within the network at the same time.

Note that according to one or more embodiments of the techniques herein, once an issue is detected using the sliced monitoring techniques above, end-to-end monitoring may be enabled for a given flow. That is, if a flow is flagged by a monitoring device (e.g., a router or a controller), such as if the telemetry suggests a potential problem with that flow, then that flow could be monitored on every hop (e.g., from a reserved space of monitoring resources). By formulating criteria for all nodes to monitor a set of flow(s) that exhibit questionable behavior as per what has been reported by one or more nodes from the smaller set, and programming/deprogramming these flows on all nodes of the flow, the techniques herein can dynamically establish a complete monitoring scheme for any flows of concern. Said differently, based on monitoring performed by the set of nodes, the techniques herein may detect a trigger to instruct an increased number of nodes along a particular flow (e.g., all nodes, all capable nodes, or a larger subset of nodes along the particular flow) to monitor the particular flow. The trigger may be things such as particular errors or a particular number of errors (e.g., packet drops, etc.), crossing a static or dynamically established threshold of a particular attribute (e.g., latency, jitter, etc.), and so on. Also, instructing the nodes may include such things as indicating a pre-defined time period to monitor the particular flow, transmitting a subsequent instruction to terminate monitoring of the particular flow (e.g., based on when the attribute threshold values come back to normal), and so forth. Note, too, that the techniques herein may first determine and reserve some defined amount of monitoring resources on the set of nodes sufficient for subsequent instructions to monitor a given flow in response to such triggers above (e.g., determining the defined amount of monitoring resources based on a number of flows and/or a number of nodes).

In one embodiment, the techniques herein may perform a flow classification for group and sub-group assignments according to the specific resource constraints of the nodes. For instance, groupings may be based on particular types of flows such as video versus audio, data versus control, high priority versus low priority, and so on. Even within types of flows, certain sub-types may also be used for flow classification, such as various video categories, e.g., news, sports, movies, etc., or even further granularity such as sub-groups based on long-tail, short-tail, 2k, 4k, local, regional, etc.

Also, in another embodiment, any adjustable time periods or trigger sensitivity for updating the monitoring of any given flows (e.g., specific events, crossed thresholds, etc.) may also be specific to the corresponding grouping and/or the specific trigger. For instance, the length of time an end-to-end monitoring is performed may be more or less for certain types of flows and/or errors, etc., and may be determined dynamically or set by operator policies.

Further, since the number of hops/nodes per flow between every ingress-egress pair may be different (unlike what is assumed in the figures above) and can change over time, in still another embodiment, the techniques herein can adjust monitoring policy formulation and placement logic to continually or occasionally optimize the number of hops (hop-set) that would qualify to monitor a particular group/sub-group for a period of time. Other updates may also be made occasionally based on changing capabilities of the nodes and/or the number of flows, etc.

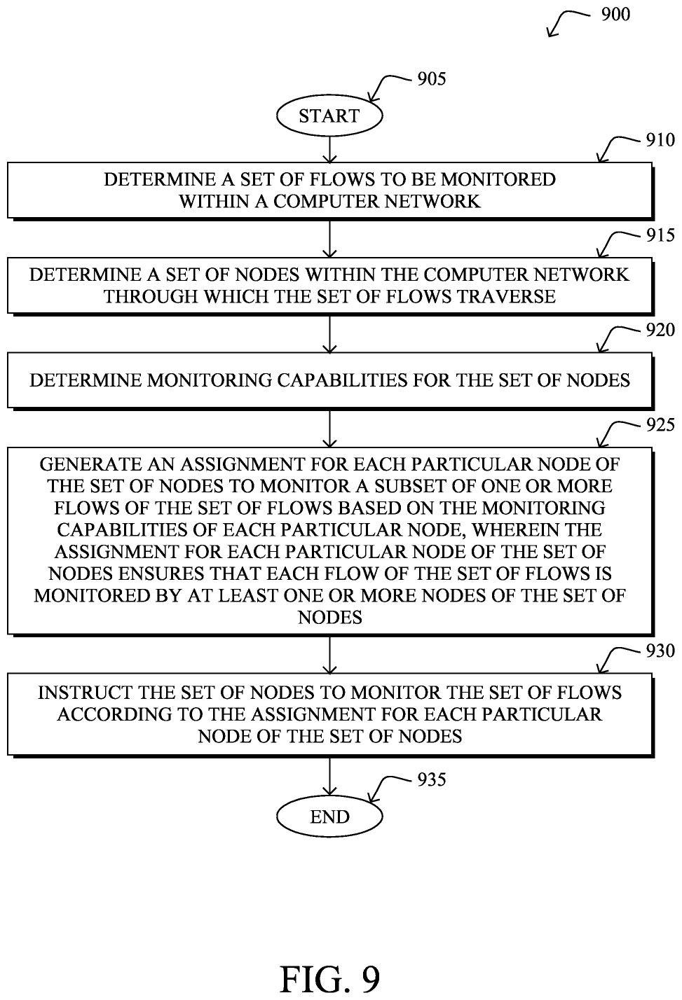

In closing, FIG. 9 illustrates an example simplified procedure for sliced flow telemetry for full network visibility with limited hardware resources in accordance with one or more embodiments described herein, particularly from the perspective of a centralized controller or management device, accordingly. For example, a non-generic, specifically configured device (e.g., device 200) may perform procedure 900 by executing stored instructions (e.g., process 248). The procedure 900 may start at step 905, and continues to step 910, where, as described in greater detail above, the techniques herein determine a set of flows to be monitored within a computer network (e.g., using a same ingress and a same egress of the computer network), and then determine, in step 915, a set of nodes within the computer network through which the set of flows traverse. In step 920 the techniques herein may then determine monitoring capabilities for the set of nodes (e.g., based on hardware-based telemetry monitoring on the set of nodes). Note that in one embodiment, the techniques herein may also determine and reserve a small percentage of monitoring resources on each node (e.g., based on total number of flows and nodes, etc.) in case one or more flows need to be monitored end-to-end as needed for a period of time, as described herein.

In step 925, the techniques herein may then generate an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes. In one embodiment, a same subset of the set of nodes may be assigned to monitor a particular subset of the set of flows (e.g., node subset “A” monitors flow subset “A”, node subset “B” monitors flow subset “B”, and so on). In other embodiments, different arrangements may be made between which nodes monitor which flows. For example, each particular node of the set of nodes may be assigned an individualized number of flows to monitor based on an individual node-by-node-based determination of the monitoring capabilities of that particular node (e.g., a one-to-one determination).

In step 930, the techniques herein may then instruct the set of nodes to monitor the set of flows according to the assignment for each particular node of the set of nodes. Note that in certain embodiments, and at certain times, the set of nodes may monitor the set of flows according to one or more configured sampling mechanisms, in addition to the slicing of the flows described above.

The simplified procedure 900 may then end in step 935, notably with the ability to continue updating a number of the set of flows to be monitored and/or the monitoring capabilities for the set of nodes. Other steps may also be included generally within procedure 900. For example, such steps (or, more generally, such additions to steps already specifically illustrated above), may include: reserving a defined amount of monitoring resources on the set of nodes sufficient for subsequent instructions (e.g., to monitor a given flow in response to a trigger to end-to-end monitor the given flow, etc.); detecting, based on monitoring performed by the set of nodes, a trigger to instruct an increased number of nodes along a particular flow of the set of flows to monitor the particular flow, and instructing, based on the trigger, the increased number of nodes along the particular flow to monitor the particular flow; and so on.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for sliced flow telemetry for full network visibility with limited hardware resources. In particular, the techniques herein provide per-flow network visibility without requiring per-flow counters in hardware. For instance, the techniques herein can provide a complete picture of overall network health based on the sliced views and optional periodic monitoring at certain times. Specifically, the techniques herein are able to monitor 100% of the flows in a network where hardware could not otherwise support such complete monitoring on every node by “slicing” the monitoring responsibilities for the flows of a network (or network segment) across the nodes of the network in order to collect more monitoring data than hardware resources traditionally allow. The techniques herein thus scale better than traditional techniques and allow for monitoring greater numbers of flows, accordingly.

In addition, the techniques herein have the capability to move to an end-to-end monitoring configuration in response to a detected drop or other concern. That is, the techniques herein provide an optimal way to detect anomalies or other detected issues in traffic, per application quality of service, with limited hardware resources, and then provide for enabling complete end-to-end monitoring in response, accordingly. Note that while certain current techniques allow for manually enabling and disabling multicast statistic collection (e.g., per bridge domain level or VRF level), these techniques are still limited by hardware capacity. That is, these counter resources are shared resources and cannot be expected to be available for multicast purposes for all the flows, and can thus only provide telemetry data to partial flows.

Note, the techniques herein are not “sampling”, which traditionally implies taking a portion of measurements. Rather, the techniques herein actually distribute the responsibility of monitoring all flows among the nodes of the network so that all (100%) flows of the network are actually monitored, but only within a portion of the network (i.e., a subset of all of the nodes). The techniques herein may take advantage of sampling techniques on each node (slicing herein could be complementary to sampling), however the “slicing” herein (assigning responsibility to a subset of the nodes) is not to be confused with “sampling” (taking in only a portion of the information about the flows), accordingly. That is, in sampling, for example, one packet out of ‘n’ packets is processed, whether the first packet (deterministic) or any packet out of ‘n’ (random), across a number of flows or just one flow, in a same or different manner across the nodes/interfaces, and so on. The techniques herein, on the other hand, select a particular number of flows on a particular number of hops over a particular time-period to maximize the coverage of monitoring almost all of the flows in a manner that is more comprehensive.

Illustratively, the techniques described herein may be performed by hardware, software, and/or firmware, such as in accordance with the illustrative sliced flow telemetry correlation process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248. Notably, the device performing the techniques herein (e.g., particularly the algorithm to determine the need and assign the responsibilities herein) may be any suitable device such as a controller, a server, a management device, a monitoring application, or other authoritative system, device, or program, accordingly. Note too that the “device” performing the operations herein could be a part of the management plane, or control plane, or data plane that each node is part of.

According to the embodiments herein, an illustrative method herein may comprise: determining, by a device, a set of flows to be monitored within a computer network; determining, by the device, a set of nodes within the computer network through which the set of flows traverse; determining, by the device, monitoring capabilities for the set of nodes; generating, by the device, an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and instructing, by the device, the set of nodes to monitor the set of flows according to the assignment for each particular node of the set of nodes.

In one embodiment, the method further comprises: detecting, based on monitoring performed by the set of nodes, a trigger to instruct an increased number of nodes along a particular flow of the set of flows to monitor the particular flow; and instructing, based on the trigger, the increased number of nodes along the particular flow to monitor the particular flow. In one embodiment, the increased number of nodes is all nodes along the particular flow. In one embodiment, the trigger is selected from a group consisting of: one or more particular errors; a particular number of errors; crossing a static threshold of a particular attribute; and crossing a dynamically established threshold of a particular attribute. In one embodiment, instructing the increased number of nodes along the particular flow to monitor the particular flow comprises one of either: a) indicating a pre-defined time period for the increased number of nodes along the particular flow to monitor the particular flow; or b) transmitting a subsequent instruction to have the increased number of nodes along the particular flow terminate monitoring of the particular flow.

In one embodiment, the method further comprises: reserving a defined amount of monitoring resources on the set of nodes sufficient for subsequent instructions to monitor a given flow in response to a trigger to end-to-end monitor the given flow. In one embodiment, the method further comprises: determining the defined amount of monitoring resources based on one or both of a total number of the set of flows and a total number of the set of nodes.

In one embodiment, the set of nodes further monitor the set of flows according to one or more configured sampling mechanisms.

In one embodiment, a same subset of the set of nodes is assigned to monitor a particular subset of the set of flows.

In one embodiment, each particular node of the set of nodes is assigned an individualized number of flows to monitor based on an individual node-by-node-based determination of the monitoring capabilities of that particular node.

In one embodiment, the set of flows use a same ingress and a same egress of the computer network.

In one embodiment, the method further comprises: updating one or both of a) a number of the set of flows to be monitored and b) the monitoring capabilities for the set of nodes.

In one embodiment, determining monitoring capabilities is based on hardware-based telemetry monitoring on the set of nodes.

According to the embodiments herein, an illustrative tangible, non-transitory, computer-readable medium herein may have computer-executable instructions stored thereon that, when executed by a processor on a computer, may cause the computer to perform a method comprising: determining a set of flows to be monitored within a computer network; determining a set of nodes within the computer network through which the set of flows traverse; determining monitoring capabilities for the set of nodes; generating an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and instructing the set of nodes to monitor the set of flows according to the assignment for each particular node of the set of nodes.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: determine a set of flows to be monitored within a computer network; determine a set of nodes within the computer network through which the set of flows traverse; determine monitoring capabilities for the set of nodes; generate an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and instruct the set of nodes to monitor the set of flows according to the assignment for each particular node of the set of nodes.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. For instance, while flows herein are typically address as multicast flows (e.g., video flows), any other flows, streams, data, transmissions, and so on may make use of the techniques herein. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
determining, by a device, a set of flows to be monitored within a computer network;
determining, by the device, a set of nodes within the computer network through which the set of flows traverse;
determining, by the device, monitoring capabilities for the set of nodes;
generating, by the device, an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and
instructing, by the device, the set of nodes to monitor the set of flows according to the assignment for each particular node of the set of nodes.

2. The method as in claim 1, further comprising:
detecting, based on monitoring performed by the set of nodes, a trigger to instruct an increased number of nodes along a particular flow of the set of flows to monitor the particular flow; and
instructing, based on the trigger, the increased number of nodes along the particular flow to monitor the particular flow.

3. The method as in claim 2, wherein the increased number of nodes is all nodes along the particular flow.

4. The method as in claim 2, wherein the trigger is selected from a group consisting of: one or more particular errors; a particular number of errors; crossing a static threshold of a particular attribute; and crossing a dynamically established threshold of a particular attribute.

5. The method as in claim 2, wherein instructing the increased number of nodes along the particular flow to monitor the particular flow comprises one of either:
a) indicating a pre-defined time period for the increased number of nodes along the particular flow to monitor the particular flow; or
b) transmitting a subsequent instruction to have the increased number of nodes along the particular flow terminate monitoring of the particular flow.

6. The method as in claim 1, further comprising:
reserving a defined amount of monitoring resources on the set of nodes sufficient for subsequent instructions to monitor a given flow in response to a trigger to end-to-end monitor the given flow.

7. The method as in claim 6, further comprising:
determining the defined amount of monitoring resources based on one or both of a total number of the set of flows and a total number of the set of nodes.

8. The method as in claim 1, wherein the set of nodes further monitor the set of flows according to one or more configured sampling mechanisms.

9. The method as in claim 1, wherein a same subset of the set of nodes is assigned to monitor a particular subset of the set of flows.

10. The method as in claim 1, wherein each particular node of the set of nodes is assigned an individualized number of flows to monitor based on an individual node-by-node-based determination of the monitoring capabilities of that particular node.

11. The method as in claim 1, wherein the set of flows use a same ingress and a same egress of the computer network.

12. The method as in claim 1, further comprising:
updating one or both of a) a number of the set of flows to be monitored and b) the monitoring capabilities for the set of nodes.

13. The method as in claim 1, wherein determining monitoring capabilities is based on hardware-based telemetry monitoring on the set of nodes.

14. A tangible, non-transitory, computer-readable medium having computer-executable instructions stored thereon that, when executed by a processor on a computer, cause the computer to perform a method comprising:
determining a set of flows to be monitored within a computer network;
determining a set of nodes within the computer network through which the set of flows traverse;
determining monitoring capabilities for the set of nodes;
generating an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and
instructing the set of nodes to monitor the set of flows according to the assignment for each particular node of the set of nodes.

15. The tangible, non-transitory, computer-readable medium as in claim 14, wherein the method further comprises:
detecting, based on monitoring performed by the set of nodes, a trigger to instruct an increased number of nodes along a particular flow of the set of flows to monitor the particular flow; and
instructing, based on the trigger, the increased number of nodes along the particular flow to monitor the particular flow.

16. The tangible, non-transitory, computer-readable medium as in claim 14, wherein the method further comprises:
reserving a defined amount of monitoring resources on the set of nodes sufficient for subsequent instructions to monitor a given flow in response to a trigger to end-to-end monitor the given flow.

17. The tangible, non-transitory, computer-readable medium as in claim 14, wherein the set of nodes further monitor the set of flows according to one or more configured sampling mechanisms.

18. The tangible, non-transitory, computer-readable medium as in claim 14, wherein a same subset of the set of nodes is assigned to monitor a particular subset of the set of flows.

19. The tangible, non-transitory, computer-readable medium as in claim 14, wherein each particular node of the set of nodes is assigned an individualized number of flows to monitor based on an individual node-by-node-based determination of the monitoring capabilities of that particular node.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine a set of flows to be monitored within a computer network;
determine a set of nodes within the computer network through which the set of flows traverse;
determine monitoring capabilities for the set of nodes;
generate an assignment for each particular node of the set of nodes to monitor a subset of one or more flows of the set of flows based on the monitoring capabilities of each particular node, wherein the assignment for each particular node of the set of nodes ensures that each flow of the set of flows is monitored by at least one or more nodes of the set of nodes; and
instruct the set of nodes to monitor the set of flows according to the assignment for each particular node of the set of nodes.
